(19) United States
(12) Patent Application Publication
(10) Pub. No.: US 2008/0115681 A1
(43) Pub. Date: May 22, 2008

(54) Cleaning device for a printing mechanism

(76) Inventor: Shirley Lee, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/602,781

(22) Filed: Nov. 20, 2006

(51) Int. Cl. B41F 35/00

(52) U.S. Cl. 101/425

(57) ABSTRACT

A cleaning device for a printing mechanism includes a substrate; and a layer of adherent material deposited on at least one side of the substrate. The adherent material collects buildup from at least one component of the printing mechanism at operating temperatures in the printing mechanism. A method of removing buildup from at least one internal component of a printing mechanism includes collecting buildup from the component of the printing mechanism with an adherent material on a substrate that passes through a print media feed path of the printing mechanism.

### BACKGROUND

Printed materials have consistently played a significant role in shaping society for more than 600 years. Consequentially, many devices exist that allow information such as images and text to be reproduced on various media.

Some of the most efficient and economical printing mechanisms currently available in the market utilize a technology known as liquid electrophotography. FIG. 1 illustrates an exemplary liquid electrophotography printing mechanism.

Referring to FIG. 1, the liquid electrophotography printing mechanism (100) generally operates by projecting an image to be printed from a writing head (180) onto a photo imaging cylinder (120) with a photoconductive surface. The photoconductive surface of the photo imaging cylinder (120) thus retains a latent copy of the projected image. Ink injectors (190) then dispense ink onto a developer roller (110). The develop roller (110) then delivers the ink to the surface of the photo imaging cylinder (120) to develop the latent image being printed.

The developed ink image is then transferred to a printing drum (130) from which it is, in turn, transferred to a print medium (150). The medium (150) is compressed between the printing drum (130) and a compression cylinder (140) to transfer the ink image from the printing drum (130) to the medium (150). A workstation (170) may be used to control printing operations in the printing mechanism (100).

A consumable component, known as a printing blanket (160), is disposed around the circumference of the cylindrical printing drum (130). The printing blanket (160) is composed of a material that is able to accept the liquid ink from the photo imaging cylinder (120) and clearly transfer the ink image to the print medium (150) with minimal retention of ink in the printing blanket (160). This characteristic of the printing blanket (160) is sometimes known as its “releasability,” that is the ability of the printing blanket (160) to release the ink to the print medium (150). Good releasability of the printing blanket (160) is important to achieve good print quality and effective use of printing materials.

Over time, the releasability of the printing blanket may deteriorate, causing the printing blanket (160) to retain more ink and thereby decrease the quality of images printed with the printing mechanism (100). This condition may be referred to as release loss or gloss memory. It is believed that this loss of performance in the printing blanket (160) is a result of a buildup of ink residue at the printing blanket (160).

Several approaches to the problem of ink residue buildup on printing blankets (160) are known in the art. One of them includes printing several pages of a solid color in hopes that the ink residue materials will stick to the ink being printed and transfer from the printing blanket (160) to the medium (150). Yellow is often selected because one can see whether the buildup is adhering to the yellow ink. This approach, however, has not proven very effective and is also costly and time consuming.

Other approaches to the problem including wiping the printing blanket (160) with a solvent or a cleaning solution. This generally requires a user to stop the printing mechanism (100), access the printing drum (120) and physically clean the printing blanket (160), which may be hot. In addition to posing a potential safety risk to the user, valuable time may be lost when manually cleaning the printing blanket (160) in this manner. Moreover, not all cleaning solutions are effective against the types of buildup developed in the printing blanket.

### SUMMARY

A cleaning device for a printing mechanism includes a substrate; and a layer of adherent material deposited on at least one side of the substrate. The adherent material collects buildup from at least one component of the printing mechanism at operating temperatures in the printing mechanism. A method of removing buildup from at least one internal component of a printing mechanism includes collecting buildup from the component of the printing mechanism with an adherent material on a substrate that passes through a print media feed path of the printing mechanism.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a perspective view of an exemplary embodiment of a printing mechanism according to principles described herein.

FIG. 2 is a cross-sectional side view of an exemplary embodiment of a cleaning device for a printing mechanism according to principles described herein.

FIG. 3 is a cross-sectional side view of an exemplary embodiment of a cleaning device for a printing mechanism according to principles described herein.

FIGS. 4A and 4B are illustrative functional views of an exemplary embodiment of a cleaning device removing buildup from a printing mechanism according to principles described herein.

FIG. 5 is a flowchart illustrating an exemplary method of removing buildup from a printing blanket according to principles described herein.

FIG. 6 is a flowchart illustrating an exemplary method of fabricating a cleaning device for a printing apparatus according to principles described herein.

Throughout the drawings, identical reference numbers designate similar, but not necessarily identical, elements.

### DETAILED DESCRIPTION

The present specification describes an exemplary device and methods for cleaning a printing blanket of a printing mechanism to remove material buildup and extend the useful life of the blanket, without requiring that the user access the blanket for manual cleaning. An exemplary cleaning device, as disclosed herein, may include a substrate that can be processed through a printing mechanism like a sheet of print medium. The substrate has thereon a layer of adherent material that softens and become adhesive or more adhesive at the operating temperatures of the printing mechanism. This layer of adherent material then collects material buildup from the printing blanket, causing that buildup to adhere to the substrate. The accumulated buildup thus passes through and out of the printing mechanism with the adherent material layer on the substrate. Consequently, this exemplary cleaning device provides an efficient, cost-effective solution for removing buildup, such as organic ink deposits, from printing blankets of liquid electrophotography printing mechanisms.

Before particular embodiments of the present device and methods are disclosed and described, it is to be understood that the exemplary device and method are not limited to the particular materials and processes disclosed herein, as such may vary to some degree. It is also to be understood that the terminology used herein is used for the purpose of describing particular embodiments only and is not intended to be limiting, as the scope of the present device and methods will be defined only by the appended claims and equivalents thereof.

As used in the present specification and the appended claims, the term “printing blanket” is meant to be understood as any material disposed on a rotatable cylinder in a printing mechanism that is used to transfer a liquid ink image to a print medium. The printing blanket may be fabricated as a cylinder that is configured to fit around the rotatable cylinder or drum of the printing mechanism. The term “print medium” refers broadly to any medium on which a printing mechanism may print an image including, but not limited to, paper, fabric, foil, plastic, glass, or silicon

As used in the present specification and the appended claims, the term “buildup” refers to an accumulation or deposit of one or more materials on a surface.

As used in the present specification and the appended claims, the term “adherent material” refers broadly to a material to which the buildup on a printing blanket will adhere so that the buildup can be removed from the printing blanket. In some embodiments, the adherent material may be dry and non-adhesive at room temperature, but then soften, melt or become more adhesive at the operating temperatures experienced within a printing mechanism, such as at a printing blanket in a liquid electrophotography printing mechanism. The adherent material may be, for example, a polymer such as a thermoplastic elastomer. The term “thermoplastic elastomer” is meant to be understood as a rubber-like synthetic substance characterized by increasing softness, flexibility, and adhesion when heated.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a percentage range of approximately 1% to about 20% should be interpreted to include not only the explicitly recited percentage limits of 1% to about 20%, but also to include individual percentages such as 2%, 3%, 4%, and sub-ranges such as 5% to 15%, 10% to 20%, etc.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

In one of many possible embodiments, the present specification described a cleaning device for a printing mechanism having a substantially flat, flexible substrate and a layer of adherent material, such as a thermoplastic elastomer material, deposited on at least one side of the substrate. The adherent material has a melting point at or about an operating temperature of a portion of the printing mechanism to be cleaned.

The present specification also describes a method of removing buildup from a printing blanket by providing a cleaning device having a substantially flat flexible substrate and a layer of adherent material deposited on a surface thereon, receiving the cleaning device into a printing mechanism having a cylinder including the printing blanket, and compressing the layer of adherent material against the printing blanket while rotating the cylinder. The buildup adheres to the layer of adherent material. The adherent material may, in some embodiments, include a thermoplastic elastomer.

The present specification also describes a method of fabricating a cleaning device for a printing mechanism by providing a substantially flat, flexible substrate and depositing a layer of adherent material on at least one side of the substrate. The adherent material may, in some embodiments, include a thermoplastic elastomer.

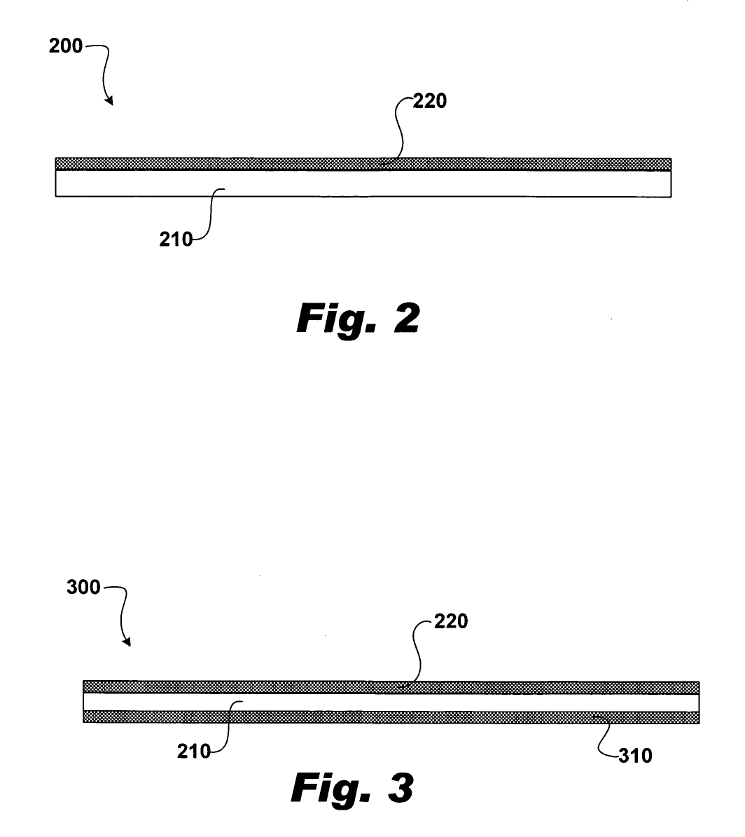

Referring now to FIG. 2, an exemplary embodiment of a cleaning device (200) for a printer or printing mechanism (100) is shown. The cleaning device (200) comprises a substrate (210) and a layer (220) of adherent material deposited upon a side of the substrate (210). The substrate (210) may be a flexible substrate that is sized and shaped like a sheet of print medium that could be fed through the printing mechanism to be cleaned. The adherent material (220) may include thermoplastic elastomer material.

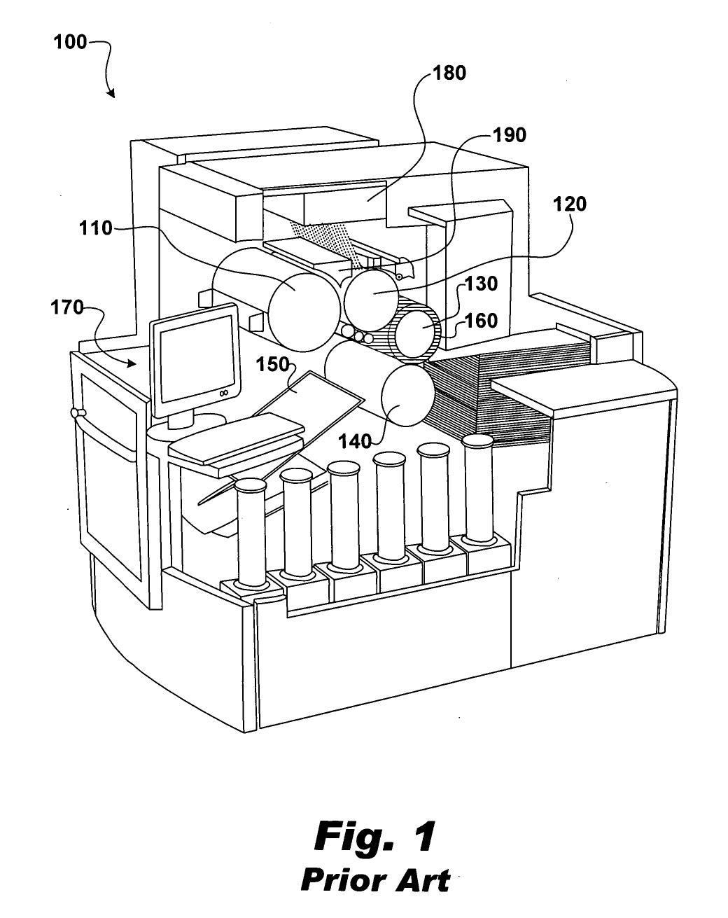

The cleaning device (200) is designed for use with a printing mechanism, such as that illustrated in FIG. 1, having a plurality of rotatable cylinders through which a print medium is fed as part of a printing process. The cleaning device (200) of the present invention may be substituted for the print medium and fed through such a printing mechanism as part of a printing process or a separate cleaning process. As it is passed through the cylinders, buildup such as ink residue may adhere to the adherent layer (220) of substrate (210) and thus be cleaned from the printing mechanism as will be explained in more detail below.

As indicated above, in order to pass through a system of rotating cylinders in such is found in a printing mechanism, a flat and flexible substrate (210) is used. The substrate (210) may be, for example, a sheet of printing paper on which an adherent material has been applied. In such an example, the paper substrate may be a heavier weight paper that is typical for a print medium to better support the adherent material (220) and collected buildup. In other alternatives, the substrate (210) may include, but is in no way limited to, a plastic transparency sheet, cardstock, fabric, vinyl, and combinations thereof.

In some examples, the layer (220) of adherent material has a melting point at or about an operating temperature of a portion of the printing mechanism to be cleaned. In this regard, the term “about” means that the melting point of the adherent material is sufficiently close to the operating temperature of a portion of the printing mechanism that the ability of the adherent material to collect buildup from the printing mechanism is increased when the adherent material is heated by that operating temperature of at least a portion of the printing mechanism.

This property allows the cleaning device (200) to remain dry and clean as it is fed through the printing mechanism. Upon reaching a portion of the printing mechanism to be cleaned, the adherent material is warmed and will exhibit an increased ability to collect buildup which then adheres thereto. For example, the adherent material may loose structure integrity or melt slightly, becoming a hot-melt adhesive, when exposed to the internal heat of the printing mechanism. In such a state, buildup such as organic ink residue adheres to the layer (220) of adherent material and will be removed from the printing mechanism as the cleaning device (200) is passed through the printing mechanism.

As the cleaning device (200) may be especially useful in removing buildup from a printing blanket (160; FIG. 1) of a liquid electrophotography printing mechanism (100; FIG. 1), an adherent material having a melting point at or about the operating temperature of the printing blanket (160; FIG. 1) may be selected for use in the layer (220) of adherent material. In some examples, this adherent material comprises a thermoplastic elastomer material.

For example, due to the fact that many printing blankets (160; FIG. 1) operate at around 100° C., an adherent material, e.g., a thermoplastic elastomer, having a melting point between 90° C. and 110° C. may be used. Such an adherent material may include, for example, styrene-ethylene-butylene-styrene copolymer or SEBS (also known as hydrogenated styrene-butadiene-styrene). An additional benefit of styrene-ethylene-butylene-styrene copolymer may be present in the reduced susceptibility of the cleaning device to oxidation through elimination of double-bonds in the thermoplastic elastomer material. Other possible thermoplastic elastomer materials that may be used in the layer (220) of the cleaning device (200) include, but are in no way limited to, tri-block copolymers (TPE-S), urethane thermoplastic elastomers (TPE-U), polyether esters (TPE-E), polyether amides (TPE-A), and combinations thereof.

The layer (220) of adherent material may have a thickness sufficient enough to effectively remove buildup from the printing mechanism but sufficiently thin to prevent adverse consequences, such as misfeeds or jams, in the printing mechanism. For example, the layer (220) may comprise a thickness between 5 and 50 microns.

Referring now to FIG. 3, in some embodiments, a cleaning device (300) may comprise both a first layer (220) of adherent material and a second layer (310) of adherent material disposes on opposite sides of the substrate (210). Either or both layers of adherent material may comprise, for example, a thermoplastic elastomer.

This particular configuration, a layer of adherent material on both sides of the substrate, may be beneficial when the cleaning device (300) is passed through a printing mechanism comprising cylinders or printing blankets on either side of print medium feed path that accumulate buildup that needs to be removed. The first (220) and second (310) layers of adherent material may have equal or different thicknesses, and in some embodiments may include different adherent materials, according to the specific characteristics of the printing mechanism to be cleaned.

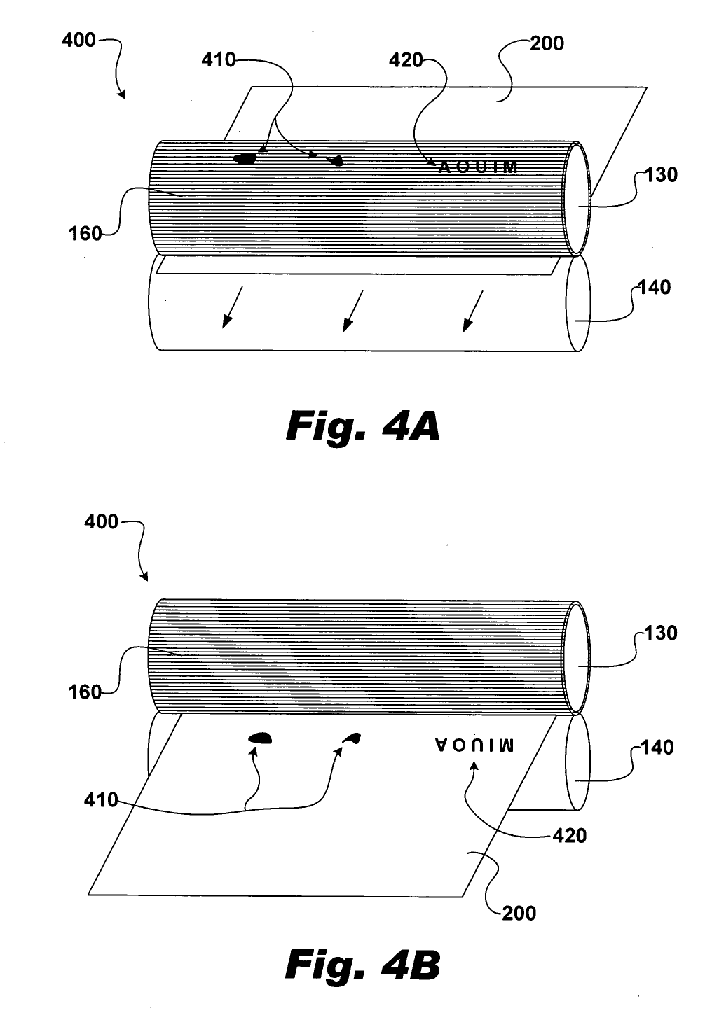

FIG. 4, including FIGS. 4A and 4B, is an illustrative functional view of an exemplary embodiment of a cleaning device (200) removing buildup from a printing mechanism (400) according to principles described herein. In the example of FIG. 4, the printing mechanism (400) comprises a printing drum (130) and a compression cylinder (140). The printing mechanism (400) is configured to pass a print medium (150; FIG. 1) between the printing drum (130) and the compression cylinder (140) by rotating the cylinders (130, 140). The printing drum (130) comprises a printing blanket (160) disposed about its circumference.

In a normal printing process, an image in wet ink may be transferred to the printing blanket (160) of the printing drum (130) and thereafter from the printing blanket (160) to the print medium (150; FIG. 1). The compression cylinder (140) compresses the print medium (150; FIG. 1) against the printing blanket (160) ideally providing a complete, clear transfer of the ink image to the print medium (150; FIG. 1).

As noted herein, over time, the printing blanket (160) may accumulate buildup (410, 420), especially organic residue from ink materials. The buildup (410, 420) may include both “stacked” accumulations of ink solids (410) and accumulations from ink images (420) that do not completely transfer to the print medium (150; FIG. 1).

The cleaning device (200) described herein may be used to remove the buildup (410, 420) from the printing blanket (160) of the printing drum (130). The cleaning device (200) includes a layer (220; FIG. 2) of adherent material, such as a thermoplastic elastomer, with a melting point at or about the operating temperature of the printing blanket (160).

As the cleaning device (200) is passed through the printing drum and compression cylinders (130, 140, respectively) in the direction indicated by the arrows, the adherent material is heated to its melting point by the operating temperature of the printing blanket (160). This heating results in the adherent material becoming adhesive or sticky and in effect pulling the buildup (410, 420) off of the surface of the printing blanket (160) as the buildup comes in contact with the layer (220; FIG. 2) of adherent material. Thus, upon removal from the surface of the printing blanket (160), the buildup (410, 420) is transferred to the surface of the cleaning device (200) having the layer (220; FIG. 2) of adherent material.

One of the many possible advantages in using the cleaning device (200) described herein to remove buildup from a printing blanket (160) of a printing mechanism (400) is the opportunity it affords the manufacturers of the printing mechanism to analyze the types and makeup of buildup being accumulated on the printing blanket (160). Findings from such analysis may provide new insight into ways to prevent or decrease buildup in later models of the printing blanket (160) or printing mechanism (400).

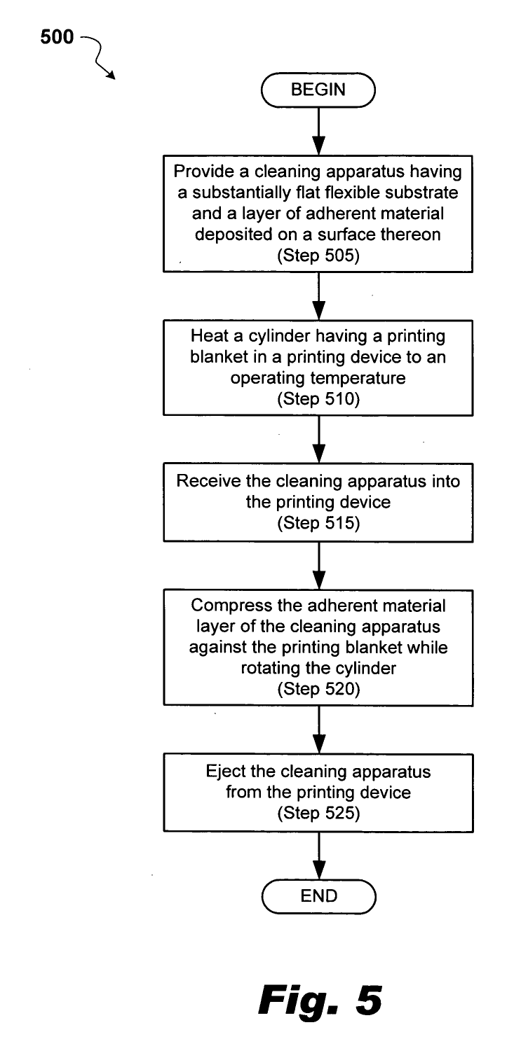

Referring now to FIG. 5, a flowchart of an exemplary method (500) of removing buildup from a printing blanket in a printing mechanism is shown. According to the method (500), a cleaning device is provided (step 505), the cleaning device having a substantially flat, flexible substrate and a layer of adherent material deposited on a surface thereon. In the printing mechanism, a cylinder having the printing blanket is heated (step 510) to an operating temperature. According to some embodiments, this temperature may be approximately 100° C.

The cleaning device is then received (step 515) into the printing mechanism. In some embodiments, the cleaning device may be inserted into a stack of paper or other print media to be printed by said printing mechanism. In such embodiments, the cleaning device may be received into the printing mechanism during a normal printing operation for the printing mechanism. Thus, the printing mechanism can be cleaned during or between printing jobs as preventative maintenance without interrupting normal work flow.

In some embodiments, multiple cleaning devices may be inserted into a stack of print media. In some such examples, cleaning devices with adherent material on only a single side may be inserted into a stack of print media with the adherent material sides oriented in opposite directions so that cleaning is provided to components on both sides of a print material feed path. Alternatively, a cleaning device, described above, with adherent material on both sides may similarly clean components on both sides of a print material feed path.

The layer of adherent material on the cleaning device may be heated by the operating temperature of the cylinder and printing blanket or other internal components of the printing mechanism. As described above, this may activate or increase the adhesive quality of the adherent material. The layer of adherent material is then compressed (step 520) against the printing blanket while the cylinder having the printing blanket disposed thereon is rotated.

The buildup adheres to the layer of adherent material, and the cleaning device is then ejected (525) from the printing mechanism. The steps of compressing and ejecting (steps 520, 525) may also be part of a normal printing operation for the printing mechanism. In some examples, analysis of the buildup may then be conducted.

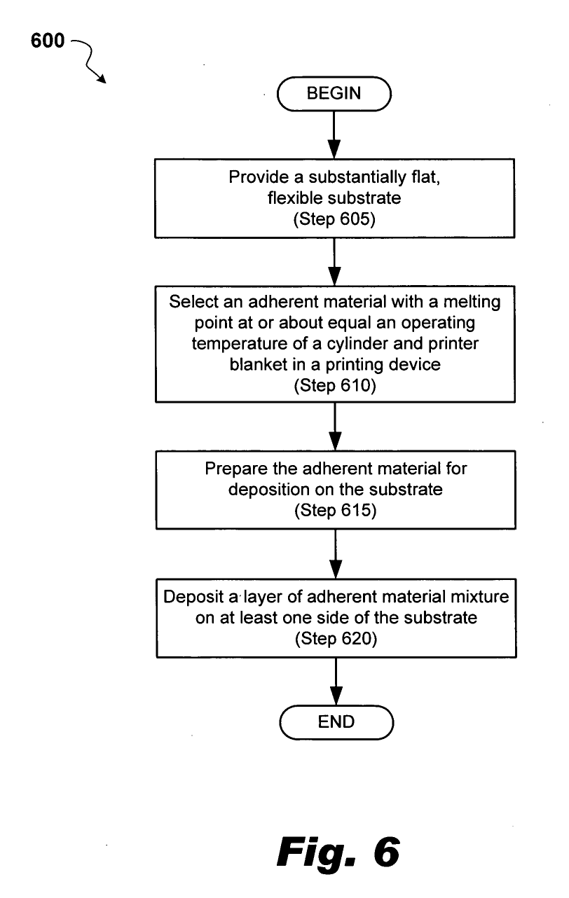

Referring now to FIG. 6, a flowchart illustrates an exemplary method (600) of fabricating a cleaning device for a printing mechanism.

The method (600) includes the step of providing a substantially flat, flexible substrate (step 605). The substrate may be selected from the group consisting of a sheet of paper, a plastic transparency sheet, cardstock, fabric, vinyl, foil, other suitable materials and combinations thereof. For example, “M-real Silver Digital Matte” paper stock from Mead corporation and “High-Tech Smooth/Lisse Bright white 94” paper stock available from Rolland corporation may be used as the substantially flat, flexible substrate, in addition to many other materials.

Once the substrate is provided (step 605), the exemplary method (600) includes the step of selecting (step 610) an adherent material having a melting point at or about equal an operating temperature of a cylinder and printer blanket in a printing mechanism to be cleaned by the cleaning device. The adherent material may include a thermoplastic elastomer such as, but not limited to, styrene-ethylene-butylene-styrene copolymer (SEBS), tri-block copolymers (TPE-S), urethane thermoplastic elastomers (TPE-U), polyether esters (TPE-E), polyether amides (TPE-A), and combinations thereof.

Upon selecting (step 610) the adherent material, the adherent material is prepared for deposition on the substrate. This may, in some examples, including mixing the adherent material with a solvent. In some examples, the solvent used is xylene. In one exemplary embodiment, the adherent material is a thermoplastic elastomer material that is mixed with xylene as a solvent in a ratio of 83.6% xylene and 17.4% styrene-ethylene-butylene-copolymer (SEBS). One commercial grade styrene-ethylene-butylene-copolymer found suitable for use with the present invention is Taipol 3150 made by Taiwan Synthetic Rubber Corporation.

Once prepared, the adherent material is deposited (step 620) on at least one side of the substrate. The deposition may be accomplished using an extrusion or calendaring process. For example, deposition techniques such as Meyer rod techniques, gravure coating, reverse roll coating, gap coating, slot die, immersion coating, curtain coating, air knife coating, and others known in the art may be used to deposit (step 620) the adherent material on the substrate. The layer of adherent material may be deposited at a thickness between 5 and 50 microns.

In some embodiments, a second layer of adherent material may be deposited on another side of the substrate. This layer may comprise the same or a different adherent material and may be the same or a different thickness as the first layer of adherent material.

Consequently, as described herein, a cleaning device for a printing mechanism can be manufactured in bulk as a consumable. Under a business method disclosed herein, multiple sheets of the cleaning device may be produced and packaged together for sale.

The preceding description has been presented only to illustrate and describe embodiments of the invention. It is not intended to be exhaustive or to limit the invention to any precise form disclosed. Many modifications and variations are possible in light of the above teaching.

What is claimed is:

1. A cleaning device for a printing mechanism comprising:
a substrate; and
a layer of adherent material deposited on at least one side of said substrate;
wherein said adherent material collects buildup from at least one component of said printing mechanism at operating temperatures in said printing mechanism.

2. The cleaning device of claim 1, wherein said adherent material comprises a polymer.

3. The cleaning device of claim 1, wherein said adherent material comprises a thermoplastic elastomer.

4. The cleaning device of claim 1, wherein said adherent material has a melting point at or about equal an operating temperature of a portion of the printing mechanism to be cleaned.

5. The cleaning device of claim 4, wherein said portion comprises a printing blanket.

6. The cleaning device of claim 4, wherein said melting point is between 90° C. and 110° C.

7. The cleaning device of claim 1, wherein said adherent material is dry at room temperature.

8. The cleaning device of claim 1, comprising a layer of said adherent material on both sides of said substrate.

9. The cleaning device of claim 1, wherein said adherent material comprises at least one of styrene-ethylene-butylene-styrene copolymer (SEBS) tri-block copolymers (TPE-S), urethane thermoplastic elastomers (TPE-U), polyether esters (TPE-E), polyether amides (TPE-A), and combinations thereof.

10. The cleaning device of claim 1, wherein said layer of adherent material has a thickness between 5 and 50microns.

11. A method of removing buildup from at least one internal component of a printing mechanism comprising collecting buildup from said component of said printing mechanism with an adherent material on a substrate that passes through a print media feed path of said printing mechanism.

12. The method of claim 11, further comprising heating said adherent material with an operating temperature of said printing mechanism, wherein said adherent material becomes adhesive to said buildup due to said heating.

13. The method of claim 11, wherein said adherent material comprises a polymer.

14. The method of claim 13, wherein said adherent material comprises a thermoplastic elastomer.

15. The method of claim 11, further comprising contacting a printing blanket of said printing mechanism with said adherent material to remove ink residue from said printing blanket.

16. The method of claim 15, further comprising ejecting the cleaning device from said printing mechanism.

17. The method of claim 16, further comprising analyzing buildup from said ejected cleaning device.

18. The method of claim 11, further comprising inserting said cleaning device is inserted into a stack of print medium being fed into said printing mechanism.

19. A method of fabricating a cleaning device for a printing mechanism comprising:
providing a substrate; and
depositing a layer of adherent material on at least one side of said substrate, wherein said adherent material collects buildup from at least one internal component of said printing mechanism when heated by an operating temperature of said printing mechanism.

20. The method of claim 19, wherein said adherent material comprises a polymer.

21. The method of claim 20, wherein said adherent material comprises a thermoplastic elastomer.

22. The method of claim 19, further comprising depositing a layer of adherent material on both sides of said substrate.

23. The method of claim 22, wherein different adherent materials are deposited on different sides of said substrate.

24. The method of claim 19, further comprising mixing said adherent material with a solvent to prepare said adherent material for deposition on said substrate.

25. The method of claim 19, wherein said adherent material is selected from the group consisting of styrene-ethylene-butylene-styrene copolymer (SEBS), tri-block copolymers (TPE-S), urethane thermoplastic elastomers (TPE-U), polyether esters (TPE-E), polyether amides (TPE-A), and combinations thereof.
